(19) United States
(12) Patent Application Publication
(10) Pub. No.: US 2026/0312389 A1
(43) Pub. Date: Oct. 8, 2026

(54) WIRE FIXING MEMBER AND WIRE HARNESS

(71) Applicant: SUMITOMO WIRING SYSTEMS, LTD., Yokkaichi-shi (JP)

(72) Inventor: Ryo FUJIOKA, Yokkaichi-shi (JP)

(73) Assignee: SUMITOMO WIRING SYSTEMS, LTD., Yokkaichi-shi (JP)

(21) Appl. No.: 19/639,984

(22) Filed: Apr. 6, 2026

(30) Foreign Application Priority Data
Apr. 8, 2025 (JP) 2025-063665

(51) Int. Cl. H02G 3/32

(52) U.S. Cl. CPC H02G 3/32

(57) ABSTRACT

A wire fixing member including: a fixing body that is configured to be fixed to a fixing target; a wire holder that is configured to hold a wire; and an attachment that is a separate component from the wire holder and is attached to the wire holder, wherein: the wire holder includes a lock connected to the fixing body and a band extending from the lock and being configured to hold the wire by wrapping around an outer periphery of the wire and by having a leading end of the band inserted into and engaged with the lock, the attachment has a through portion configured to allow passage therethrough of the band and is attached to the band, and the attachment includes an interposed portion configured to be interposed between the fixing target and the band in a state where the fixing body is fixed to the fixing target.

### BACKGROUND

The present disclosure relates to a wire fixing member and a wire harness.

Conventionally, wire harnesses have been provided that include a wire fixing member configured to be fixed to a vehicle body while holding a wire member. A known wire fixing member of this type includes a fixing portion capable of being fixed to a fixing target on a vehicle side, a band portion for holding a wire member, and a lock portion for locking the band portion (see JP H9-196236A, for example). The wire member can be held on the wire fixing member by wrapping the band portion around the outer periphery of the wire member and engaging the band portion with the lock portion.

### SUMMARY

However, in the above wire fixing member, due to vehicle vibrations and the like, the band portion that holds the wire member tends to vibrate. This presents a problem in that repeated vibration of the band portion may cause damage to the band portion.

An exemplary aspect of the disclosure provides a wire fixing member and a wire harness that can suppress damage to a band portion.

A wire fixing member of the present disclosure includes a fixing portion configured to be fixed to a fixing target, a wire holding portion for holding a wire member, and an attachment member that is a separate component from the wire holding portion and is attached to the wire holding portion, wherein the wire holding portion includes a lock portion connected to the fixing portion and a band portion extending from the lock portion and being configured to hold the wire member by wrapping around an outer periphery of the wire member and by having a leading end portion thereof inserted into and engaged with the lock portion, the attachment member has a through portion configured to allow passage therethrough of the band portion and is attached to the band portion, and the attachment member includes an interposed portion configured to be interposed between the fixing target and the band portion in a state where the fixing portion is fixed to the fixing target.

According to the wire fixing member and the wire harness of the present disclosure, damage to the band portion can be suppressed.

### BRIEF DESCRIPTION OF THE DRAWINGS

FIG. 1 is a schematic configuration diagram illustrating a wire harness of an embodiment;

FIG. 2 is a schematic cross-sectional view showing the wire harness of the embodiment;

FIG. 3 is an exploded perspective view showing a wire fixing member of the embodiment; and

FIG. 4 is a schematic cross-sectional view showing a wire harness of a modification example.

### EMBODIMENTS OF THE DISCLOSURE

### Description of Embodiments of Present Disclosure

### First, embodiments of the present disclosure will be listed and described.

[1] A wire fixing member of the present disclosure includes a fixing portion configured to be fixed to a fixing target, a wire holding portion for holding a wire member, and an attachment member that is a separate component from the wire holding portion and is attached to the wire holding portion, wherein the wire holding portion includes a lock portion connected to the fixing portion and a band portion extending from the lock portion and being configured to hold the wire member by wrapping around an outer periphery of the wire member and by having a leading end portion thereof inserted into and engaged with the lock portion, the attachment member has a through portion configured to passage therethrough of the band portion and is attached to the band portion, and the attachment member includes an interposed portion configured to be interposed between the fixing target and the band portion in a state where the fixing portion is fixed to the fixing target.

With this configuration, the interposed portion of the attachment member is interposed between the band portion and the fixing target in a state where the fixing portion is fixed to the fixing target. As a result, a space between the band portion and the fixing target can be reduced compared with a case where the interposed portion is not provided. Accordingly, when the band portion vibrates due to vehicle vibrations or the like, a space in which the band portion can move can be reduced. Consequently, the amount of movement of the band portion caused by vibrations due to vehicle vibrations or the like can be reduced, thereby favorably suppressing damage to the band portion caused by vehicle vibrations or the like.

[2] In clause [1] above, the attachment member may include an attachment portion attached to the band portion along a length direction of the band portion, and the interposed portion joined to the attachment portion, the attachment portion having the through portion and an opposing surface configured to face the fixing target in a state where the fixing portion is fixed to the fixing target, and the interposed portion being joined to the opposing surface.

With this configuration, the attachment portion is attached to the band portion along the length direction of the band portion. Furthermore, the interposed portion is joined to the opposing surface of the attachment portion. Accordingly, the interposed portion can be configured as a separate member from the attachment portion. Therefore, the interposed portion and the attachment portion can be made of different materials from each other. Consequently, the degree of freedom in selecting the materials for the interposed portion and the attachment portion can be increased.

[3] In clause [2] above, a configuration may be adopted in which the attachment portion is made of a material of the same type as that of the band portion, and the interposed portion is made of an elastic material.

With this configuration, the interposed portion that is to be interposed between the band portion and the fixing target is made of an elastic material. Accordingly, even when the band portion vibrates due to vehicle vibrations or the like, vibration energy can be absorbed by elastic deformation of the interposed portion made of the elastic material. As a result, the vibration of the band portion can be attenuated, thereby favorably suppressing damage to the band portion.

[4] In clause [3] above, the interposed portion may be disposed elastically compressed between the attachment portion and the fixing target in a state where the fixing portion is fixed to the fixing target.

With this configuration, when the fixing portion is fixed to the fixing target, the interposed portion is disposed in an elastically compressed state between the attachment portion and the fixing target. This compressive deformation of the interposed portion generates an elastic force that presses the band portion and the attachment member against the fixing target. Accordingly, to separate the attachment member in contact with the fixing target and the band portion attached to the attachment member from the fixing target, a force greater than or equal to the above-described elastic force is required. Therefore, it becomes easier to maintain a state in which the interposed portion is in contact with the fixing target. Consequently, vibration of the band portion caused by vehicle vibrations or the like can be favorably suppressed.

[5] In any one of clauses [1] to [4] above, a configuration may be adopted in which the band portion has a width along a first direction orthogonal to a length direction of the band portion, the through portion extends through the attachment member along the length direction of the band portion, and an opening width of the through portion along the first direction is smaller than the width of the band portion along the first direction.

With this configuration, after the attachment member is attached to the band portion, movement of the attachment member along the length direction of the band portion can be favorably restricted. As a result, positional displacement of the attachment member relative to the band portion in the length direction of the band portion can be suppressed.

[6] In clause [1] above, the attachment member may be constituted by a single component having the through portion and the interposed portion.

With this configuration, the attachment member, which is a single component, can reduce the space between the band portion and the fixing target. Therefore, an increase in the number of components of the wire fixing member can be favorably suppressed.

[7] A wire harness of the present disclosure includes the wire fixing member according to any one of clauses [1] to [6] above and the wire member.

With this configuration, an effect similar to that of the wire fixing member according to clause [1] above can be obtained.

### Detailed Description of Embodiments of Present Disclosure

Specific examples of a wire fixing member and a wire harness of the present disclosure will be described below with reference to the drawings. In the drawings, the configuration shown may be partially exaggerated or simplified for convenience of description. In addition, the dimensional ratios of the respective portions may differ among the drawings. The term “orthogonal” as used herein includes not only cases that are strictly orthogonal, but also cases that are substantially orthogonal, provided that the effects of the embodiments of the present disclosure are achieved. The term “facing” as used herein refers to a state where surfaces or members are positioned facing each other. The term “facing” as used herein includes not only cases where they are positioned completely facing each other but also cases where they are positioned partially facing each other. In addition, the term “facing” as used herein includes both cases where a member separate from the two parts is interposed between the two parts and cases where nothing is interposed between the two parts. The terms “first”, “second”, “third”, and the like as used herein are used solely to distinguish objects and do not imply any ranking of the objects. It should be noted that the present disclosure is not limited to these examples, but rather is indicated by the claims, and all modifications that come within the meaning and range of equivalency of the claims are intended to be embraced therein.

### Overall Configuration of Wire Harness 10

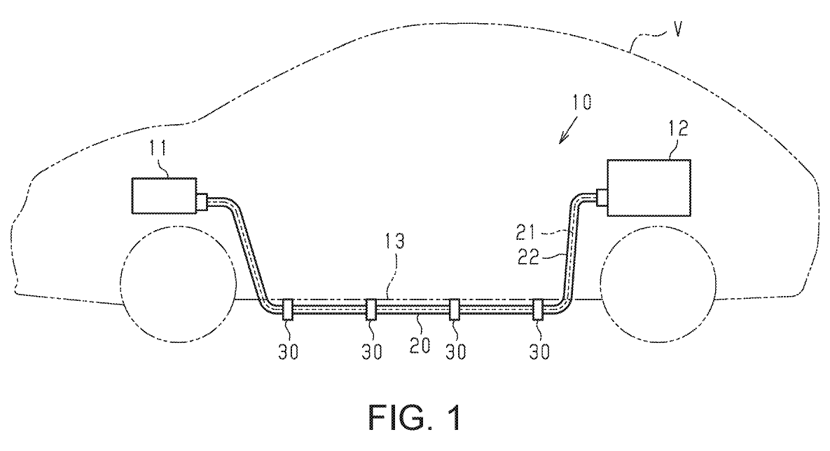

A wire harness 10 shown in FIG. 1 electrically connects two or three or more electrical devices. The wire harness 10 of an embodiment of the present disclosure electrically connects, for example, an inverter 11 installed in a front portion of a vehicle V, such as a hybrid vehicle or an electric vehicle, to a high-voltage battery 12 installed behind the inverter 11 in the vehicle V.

The inverter 11 is connected to a wheel-driving motor (not shown) that serves as a power source for vehicle propulsion. The inverter 11 generates AC power from DC power of the high-voltage battery 12 and supplies the AC power to the motor. The high-voltage battery 12 is, for example, a battery capable of supplying a voltage of several hundred volts.

The wire harness 10 is routed through regions such as under the floor of the vehicle V, for example. Specifically, for example, the wire harness 10 is routed to extend downward from the inverter 11 to below an underfloor panel 13 of the vehicle V, further extend toward a rear portion of the vehicle V through a region below the underfloor panel 13, and then extend upward to the high-voltage battery 12. It should be noted that the terms “upward” and “downward” used to describe the wire harness 10 in the present embodiment refer to upward and downward directions in a state where the wire harness 10 is fixed to the vehicle V.

The wire harness 10 includes a wire member 20 (wire) and at least one wire fixing member 30. The wire harness 10 of the present embodiment includes four wire fixing members 30. Each wire fixing member 30 fixes the wire member 20 to, for example, the underfloor panel 13 serving as a fixing target.

### Configuration of Wire Member 20

The wire member 20 includes at least one wire 21 and an exterior material 22, such as a corrugated tube, that covers the outer periphery of the wire 21. The wire 21 is connected to the inverter 11 at one end. The wire 21 is connected to the high-voltage battery 12 at the other end. The wire 21 is, for example, a high-voltage wire capable of accommodating high voltage and large current. The exterior material 22 is formed in a tubular shape. The exterior material 22 of the present embodiment is formed in a tubular shape with a circular cross-section. It should be noted that the outer periphery of the exterior material 22 forms the outer periphery of the wire member 20.

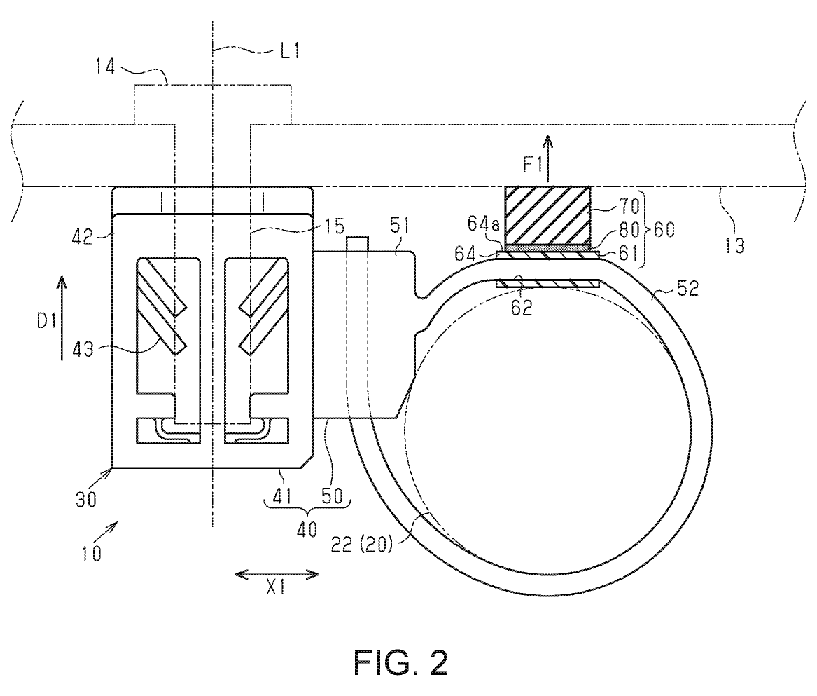

As shown in FIG. 2, the underfloor panel 13 is provided with a stud bolt 14. For example, the stud bolt 14 has a shaft portion 15 that protrudes downward from the underfloor panel 13 toward the ground. The underfloor panel 13 is provided with a plurality of stud bolts 14. The plurality of wire fixing members 30 are respectively attached to the plurality of stud bolts 14.

### Configuration of Wire Fixing Member 30

Each wire fixing member 30 includes a body member 40 and an attachment member 60 (attachment) that is a separate component from the body member 40. The body member 40 includes a fixing portion 41 (fixing body) that can be fixed to the underfloor panel 13 serving as the fixing target, and a wire holding portion 50 (wire holder) for holding the wire member 20. The fixing portion 41 is attached to the stud bolt 14, which is provided on the underfloor panel 13, in an attachment direction D1 along a central axis L1 of the shaft portion 15 of the stud bolt 14. The fixing portion 41 and the wire holding portion 50 are arranged side-by-side along a first axis X1 that is orthogonal to the attachment direction D1. The fixing portion 41 and the wire holding portion 50 are, for example, integrally formed with each other by injection molding. The body member 40 of the present embodiment is a single component in which the fixing portion 41 and the wire holding portion 50 are integrally formed in a continuous manner. The body member 40 is made of a synthetic resin, for example. Examples of materials that can be used for the body member 40 include synthetic resins such as polypropylene, polyamide, and polyacetal.

It should be noted that, in the following description, for convenience of description, the attachment direction D1 is taken as the upward direction of the wire fixing member 30, and the opposite direction is taken as the downward direction; however, the wire fixing member 30 is not necessarily used in an orientation in which the attachment direction D1 (upward direction) is vertically upward.

### Configuration of Fixing Portion 41

The fixing portion 41 is configured to allow insertion of the shaft portion 15 of the stud bolt 14 along its central axis L1. The fixing portion 41 includes an insertion portion 42 into which the shaft portion 15 can be inserted and a plurality of engagement claws 43 that protrude from an inner surface of the insertion portion 42 and can elastically engage with a threaded groove or a circumferential groove of the shaft portion 15. The plurality of engagement claws 43 of the present embodiment are provided arranged in two tiers, one pair above the other, each pair disposed on opposite sides of the shaft portion 15 in the radial direction. Thus, the fixing portion 41 can be fixed to the stud bolt 14 and the underfloor panel 13 by the engagement claws 43 engaging with the shaft portion 15 while the shaft portion 15 is inserted in the insertion portion 42.

### Configuration of Wire Holding Portion 50

The wire holding portion 50 includes a lock portion 51 (lock), and a band portion 52 (band) having flexibility and having a flexible band-like shape. The lock portion 51 is integrally formed on one side surface of the fixing portion 41 in a direction along the first axis X1. The lock portion 51 is configured to be engageable with the band portion 52 by the band portion 52 being inserted upward from below the lock portion 51. The band portion 52 is integrally formed with the lock portion 51 so as to extend from one side surface of the lock portion 51 in the direction along the first axis X1. The band portion 52 holds the wire member 20 by wrapping around the outer periphery of the exterior material 22 of the wire member 20 and by having its leading end portion inserted into and engaged with the lock portion 51. The band portion 52 is configured such that, by being inserted upward into the lock portion 51 and engaged with the lock portion 51, the band portion 52 is prevented from coming off from the lock portion 51 in a downward direction.

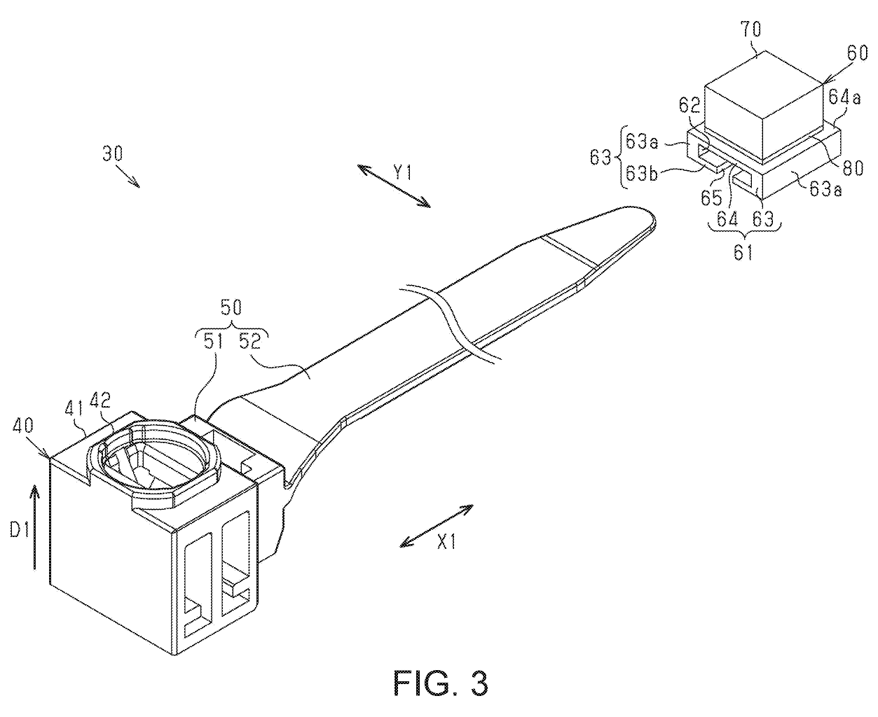

As shown in FIG. 3, the band portion 52 has an elongated thin plate shape as a whole. A length direction of the band portion 52 extends along the first axis X1 in a state before the band portion 52 is wrapped around the outer periphery of the wire member 20. The band portion 52 has a predetermined width in a first direction Y1 orthogonal to the length direction of the band portion 52. The band portion 52 includes a base end portion connected to the lock portion 51, and a leading end portion provided on the opposite side of the base end portion in the length direction of the band portion 52. The leading end portion of the band portion 52 has a tapered shape, with its width gradually decreasing toward the leading end of the band portion 52.

### Configuration of Attachment Member 60

The attachment member 60 is attached to the band portion 52 of the wire holding portion 50. The attachment member 60 is attached to the band portion 52 along the length direction of the band portion 52. For example, the attachment member 60 is attached at an intermediate position in the length direction of the band portion 52 by sliding the attachment member 60 from the leading end portion side of the band portion 52 toward the base end portion of the band portion 52.

The attachment member 60 includes an attachment portion 61 that is attached to the band portion 52, an interposed portion 70 that is joined to the attachment portion 61, and an adhesive 80 that joins the attachment portion 61 and the interposed portion 70 to each other. The attachment portion 61 and the interposed portion 70 are each constituted by separate members.

A length direction of the attachment portion 61 extends along the first axis X1. The attachment portion 61 has a through portion 62 configured to allow passage therethrough of the band portion 52. The through portion 62 is formed so as to extend through the attachment portion 61 along the length direction of the band portion 52, that is, along the first axis X1. The band portion 52 is inserted into the through portion 62 along the first axis X1. Here, the opening width of the through portion 62 along the first direction Y1 is, for example, smaller than the width of the band portion 52 along the first direction Y1. By setting such dimensions, positional displacement of the attachment portion 61 in the length direction of the band portion 52 after the attachment portion 61 has been attached at an intermediate position of the band portion 52 can be favorably suppressed.

The attachment portion 61 includes, for example, a pair of rails 63 and a connecting wall 64 that connects the pair of rails 63.

The pair of rails 63 are provided facing each other in the first direction Y1. Each rail 63 has, for example, a first wall 63a that extends along the attachment direction D1 and a second wall 63b that projects from a lower end portion of the first wall 63a toward the other rail 63. The pair of second walls 63b face each other in the first direction Y1. The pair of second walls 63b are spaced apart from each other in the first direction Y1. In other words, a gap 65 is provided between the pair of second walls 63b. The gap 65 extends along the entire length of the attachment portion 61 in the length direction of the attachment portion 61.

The connecting wall 64 is formed so as to connect upper end portions of the pair of first walls 63a to each other. The through portion 62 is defined by a space surrounded by the connecting wall 64 and the pair of rails 63. The through portion 62 of the present embodiment opens downward through the gap 65.

As shown in FIG. 2, the connecting wall 64 has an opposing surface 64a that faces the underfloor panel 13 in a state where the fixing portion 41 is fixed to the underfloor panel 13, which is the fixing target. The opposing surface 64a of the present embodiment is an upper end surface of the connecting wall 64.

The attachment portion 61 is made of a synthetic resin, for example. Examples of materials that can be used for the attachment portion 61 include synthetic resins such as polypropylene, polyamide, and polyacetal. As the material for the attachment portion 61, it is preferable to use a material of the same type as that of the band portion 52.

The interposed portion 70 is joined to the opposing surface 64a of the connecting wall 64 by, for example, the adhesive 80. The interposed portion 70 is provided so as to be interposed between the band portion 52 and the underfloor panel 13 in a state where the fixing portion 41 is fixed to the underfloor panel 13. The interposed portion 70 is provided, for example, so as to fill a space between the band portion 52 and the underfloor panel 13. Examples of materials that can be used for the interposed portion 70 include synthetic resins such as polypropylene, polyamide, and polyacetal, and elastic materials such as rubber, elastomers, and sponge. The interposed portion 70 of the present embodiment is an elastic member formed from an elastic material. The interposed portion 70 of the present embodiment is made of rubber.

As shown in FIG. 3, the interposed portion 70 is formed such that the planar size of the interposed portion 70 as viewed from above is, for example, smaller than the planar size of the opposing surface 64a. For example, the interposed portion 70 is formed such that its planar size as viewed from above is slightly smaller than the planar size of the opposing surface 64a.

As shown in FIG. 2, for example, in a state where the fixing portion 41 is fixed to the underfloor panel 13, an upper end surface of the interposed portion 70 is in close contact with the underfloor panel 13. The interposed portion 70 of the present embodiment is disposed in an elastically compressed state between the attachment portion 61 and the underfloor panel 13. At this time, the interposed portion 70 of the present embodiment generates an elastic force F1 that presses the band portion 52 and the attachment member 60 against the underfloor panel 13.

### Operation of Present Embodiment

### The operation of the wire fixing member 30 will now be described.

First, the leading end portion of the band portion 52 is inserted into the through portion 62 of the attachment portion 61 of the attachment member 60, and then, the attachment member 60 is slid toward the base end portion of the band portion 52 along the length direction of the band portion 52. By sliding the attachment member 60 in this manner, the attachment member 60 is disposed at an intermediate position in the length direction of the band portion 52, specifically at a position that is to be interposed between the band portion 52 and the underfloor panel 13 in a state where the fixing portion 41 is fixed to the underfloor panel 13. Subsequently, the band portion 52 with the attachment member 60 attached thereto is wrapped around the outer periphery of the wire member 20, and the leading end portion of the band portion 52 is engaged with the lock portion 51. As a result, the wire member 20 can be held by the wire holding portion 50. After that, the fixing portion 41 is fitted to the stud bolt 14 in the attachment direction D1 and attached thereto. At this time, the interposed portion 70 of the attachment member 60 is interposed between the band portion 52 and the underfloor panel 13. As a result, the space between the band portion 52 and the underfloor panel 13 can be reduced compared with a case where the interposed portion 70 is not provided. Accordingly, when the band portion 52 vibrates due to vehicle vibrations or the like, a space in which the band portion 52 can move can be reduced. Consequently, the amount of movement of the band portion 52 caused by vibrations due to vehicle vibrations or the like can be reduced, thereby favorably suppressing damage to the band portion 52 caused by vehicle vibrations or the like.

Furthermore, when the fixing portion 41 is fixed to the underfloor panel 13, the interposed portion 70 is disposed in an elastically compressed state between the attachment portion 61 and the underfloor panel 13. This compressive deformation of the interposed portion 70 generates an elastic force F1 that presses the band portion 52 and the attachment member 60 against the underfloor panel 13. Accordingly, to separate the attachment member 60 in contact with the underfloor panel 13 and the band portion 52 attached to the attachment member 60 from the underfloor panel 13, a force greater than or equal to the elastic force F1 is required. Therefore, it becomes easier to maintain a state in which the interposed portion 70 is in contact with the underfloor panel 13. Consequently, vibration of the band portion 52 caused by vehicle vibrations or the like can be favorably suppressed.

### Effects of Present Embodiment

### Next, the effects of the present embodiment will be described.

(1) In the wire fixing member 30, there is a possibility that the band portion 52 may vibrate in a swinging manner starting from a connecting portion between the lock portion 51 and the band portion 52 due to vehicle vibrations or the like. However, in a state where the fixing portion 41 is fixed to the underfloor panel 13, the interposed portion 70, which is included in the attachment member 60 attached to the band portion 52, is interposed between the band portion 52 and the underfloor panel 13. As a result, the space between the band portion 52 and the underfloor panel 13 can be reduced compared with a case where the interposed portion 70 is not provided. Accordingly, when the band portion 52 vibrates due to vehicle vibrations or the like, the space in which the band portion 52 can move can be reduced. Consequently, the amount of movement of the band portion 52 caused by vibrations due to vehicle vibrations or the like can be reduced, thereby favorably suppressing damage to the band portion 52 caused by swinging vibrations associated with vehicle vibrations or the like.
(2) In addition, since the interposed portion 70 is interposed between the band portion 52 and the underfloor panel 13, even when the band portion 52 vibrates due to vehicle vibrations or the like, direct contact of the band portion 52 with the underfloor panel 13 can be favorably suppressed. As a result, damage to the band portion 52 caused by repeated contact of the band portion 52 with the underfloor panel 13 can be favorably suppressed.
(3) The attachment member 60 is provided as a separate component from the wire holding portion 50. Accordingly, the material for the attachment member 60 and the material for the wire holding portion 50 can be individually selected. Therefore, the degree of freedom in selecting the materials for the attachment member 60 and the wire holding portion 50 can be increased. For example, the materials for the attachment member 60 and the wire holding portion 50 can be favorably selected according to the usage environment.
(4) The attachment portion 61 is attached to the band portion 52 along the length direction of the band portion 52. Furthermore, the interposed portion 70 is joined to the opposing surface 64a of the attachment portion 61. Accordingly, the interposed portion 70 can be configured as a separate member from the attachment portion 61. Therefore, the interposed portion 70 and the attachment portion 61 can be made of different materials from each other. Consequently, the degree of freedom in selecting the materials for the interposed portion 70 and the attachment portion 61 can be increased.
(5) The interposed portion 70 interposed between the band portion 52 and the underfloor panel 13 is made of an elastic material. Accordingly, even when the band portion 52 vibrates due to vehicle vibrations or the like, vibration energy can be absorbed by elastic deformation of the interposed portion 70 made of the elastic material. As a result, the vibration of the band portion 52 can be attenuated, thereby favorably suppressing damage to the band portion 52.
(6) The attachment portion 61 is made of a material of the same type as that of the band portion 52. With this configuration, an excessive insertion resistance when inserting the band portion 52 into the through portion 62 of the attachment portion 61 can be favorably suppressed. As a result, the assembly workability of the wire fixing member 30 can be improved.
(7) When the fixing portion 41 is fixed to the underfloor panel 13, the interposed portion 70 is disposed in an elastically compressed state between the attachment portion 61 and the underfloor panel 13. This compressive deformation of the interposed portion 70 generates an elastic force F1 that presses the band portion 52 and the attachment member 60 against the underfloor panel 13. Accordingly, to separate the attachment member 60 in contact with the underfloor panel 13 and the band portion 52 attached to the attachment member 60 from the underfloor panel 13, a force greater than or equal to the above-described elastic force F1 is required. Therefore, it becomes easier to maintain a state in which the interposed portion 70 is in contact with the underfloor panel 13. Consequently, vibration of the band portion 52 caused by vehicle vibrations or the like can be favorably suppressed.
(8) The opening width of the through portion 62 along the first direction Y1 is set to be smaller than the width of the band portion 52 along the first direction Y1. With this configuration, after the attachment member 60 is attached to the band portion 52, movement of the attachment member 60 along the length direction of the band portion 52 can be favorably restricted. As a result, positional displacement of the attachment member 60 relative to the band portion 52 in the length direction of the band portion 52 can be suppressed.

### Modification Examples

The above embodiment may be implemented with the following modifications. The above embodiment and the following modification examples can be implemented in combination with each other as long as there is no technical contradiction.

The structure of the attachment member 60 in the above embodiment may be modified as appropriate. For example, the gap 65 of the attachment portion 61 may be omitted. That is, the pair of second walls 63b of the attachment portion 61 may be connected to each other.

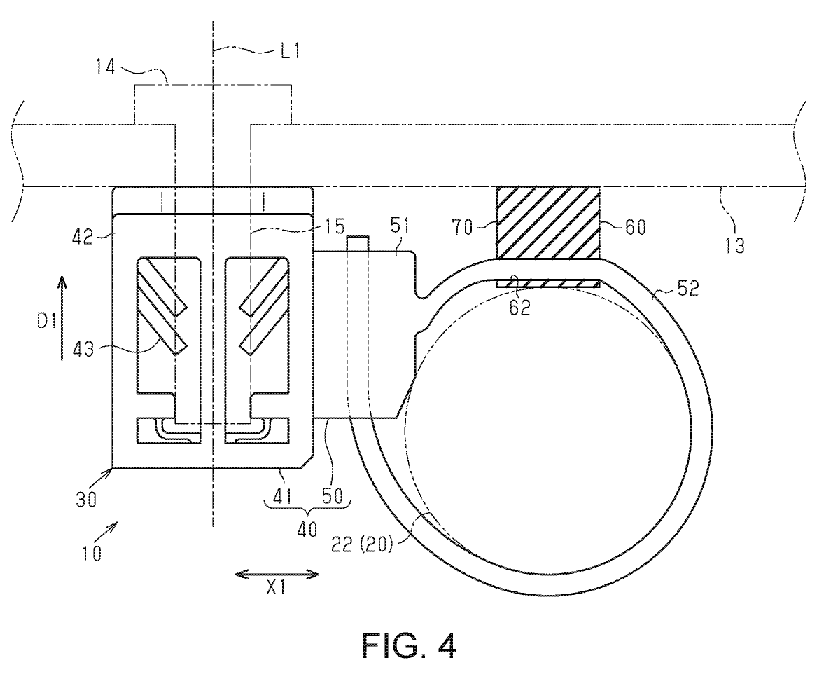

As shown in FIG. 4, the attachment member 60 may be configured as a single component having the through portion 62 and the interposed portion 70. As the material for the attachment member 60 of this modification example, for example, a synthetic resin such as polypropylene, polyamide, or polyacetal, or an elastic material such as rubber, an elastomer, or sponge can be used.

In the above embodiment, the interposed portion 70 is arranged to be in close contact with the underfloor panel 13 in a state where the fixing portion 41 is fixed to the underfloor panel 13; however, the present disclosure is not limited to this. For example, the interposed portion 70 may be arranged such that a gap is provided between the interposed portion 70 and the underfloor panel 13 in a state where the fixing portion 41 is fixed to the underfloor panel 13.

In the wire fixing member 30, the structure for fixing the fixing portion 41 to the underfloor panel 13 is not limited to that of the above embodiment, and may be modified as appropriate according to the configuration of the wire harness 10. For example, a structure may be adopted in which the fixing portion of the wire fixing member 30 is fixed by being inserted into a through hole formed in the underfloor panel 13.

The shape of the underfloor panel 13 serving as the fixing target is not limited to a planar shape and may, for example, have a curved or bent shape at a location where the stud bolt 14 is not provided. In this case, the band portion 52 of the wire fixing member 30 may face a portion of the underfloor panel 13 in the direction along the first axis X1.

In the wire fixing member 30, the wire holding portion 50 and the fixing portion 41 may be arranged side-by-side in the attachment direction D1. In this case, the interposed portion 70 of the attachment member 60 is disposed so as to be interposed between a portion of the underfloor panel 13 and the band portion 52 that face each other in the direction along the first axis X1.

In the wire fixing member 30, a configuration may be adopted in which the fixing portion 41 and the wire holding portion 50 are formed as separate parts, and the lock portion 51 of the wire holding portion 50 is attached to the fixing portion 41.

In the above embodiment, the body member 40 of the wire fixing member 30 is made of a synthetic resin; however, the present disclosure is not limited to this, and the wire fixing member 30 may be made of a metal material, for example.

In the wire member 20 of the above embodiment, the exterior material 22 may be an exterior material other than a corrugated tube.

In the above embodiment, the wire 21 included in the wire member 20 may be a low-voltage wire.

In the above embodiment, the fixing target to which the wire fixing member 30 is fixed is the underfloor panel 13; however, the present disclosure is not limited to this, and any other fixing target may be employed. It should be noted that the configuration of the fixing portion 41 of the wire fixing member 30 may be changed according to the fixing target.

The embodiments disclosed herein should be considered in all respects as illustrative and not restrictive. The scope of the present disclosure is indicated by the claims, rather than by the meaning given in the foregoing description, and all modifications that come within the meaning and range of equivalency of the claims are intended to be embraced therein.

What is claimed is:

1. A wire fixing member comprising:
a fixing body that is configured to be fixed to a fixing target;
a wire holder that is configured to hold a wire; and
an attachment that is a separate component from the wire holder and is attached to the wire holder, wherein:
the wire holder includes a lock connected to the fixing body and a band extending from the lock and being configured to hold the wire by wrapping around an outer periphery of the wire and by having a leading end of the band inserted into and engaged with the lock,
the attachment has a through portion configured to allow passage therethrough of the band and is attached to the band, and
the attachment includes an interposed portion configured to be interposed between the fixing target and the band in a state where the fixing body is fixed to the fixing target.

2. The wire fixing member according to claim 1, wherein:
the attachment includes:
an attachment portion attached to the band along a length direction of the band; and
the interposed portion joined to the attachment portion,
the attachment portion has the through portion and an opposing surface configured to face the fixing target in a state where the fixing body is fixed to the fixing target, and
the interposed portion is joined to the opposing surface.

3. The wire fixing member according to claim 2, wherein:
the attachment portion is made of a material of a same type as that of the band, and
the interposed portion is made of an elastic material.

4. The wire fixing member according to claim 3,
wherein the interposed portion is configured to be disposed elastically compressed between the attachment portion and the fixing target in a state where the fixing body is fixed to the fixing target.

5. The wire fixing member according to claim 1, wherein:
the band has a width along a first direction orthogonal to a length direction of the band,
the through portion extends through the attachment along the length direction of the band, and
an opening width of the through portion along the first direction is smaller than the width of the band along the first direction.

6. The wire fixing member according to claim 1,
wherein the attachment is a single component having the through portion and the interposed portion.

7. A wire harness comprising:
the wire fixing member according to claim 1; and
the wire.
